(19) United States
(12) Patent Application Publication
(10) Pub. No.: US 2024/0141725 A1
(43) Pub. Date: May 2, 2024

(54) SYNCHRONIZER FOR ROLLER SHADE

(71) Applicants: Mason Chou, Irvine, CA (US); Tser Wen Chou, Yorba Linda, CA (US)

(72) Inventor: Tser Wen Chou, Yorba Linda, CA (US)

(21) Appl. No.: 17/980,558

(22) Filed: Nov. 4, 2022

(30) Foreign Application Priority Data
Oct. 26, 2022 (TW) 111211705

(51) Int. Cl. E06B 9/44; E06B 9/60; E06B 9/78

(52) U.S. Cl. CPC E06B 9/44; E06B 9/60; E06B 9/78; E06B 2009/785

(57) ABSTRACT

An apparatus for even distribution of torque in a roller shade is provided. The apparatus further enhances surface rigidity of the roller, thereby minimizing the curving of the roller tubing due to the weight of the screen. The apparatus, a roller synchronizer, includes a rotation adaptor, a support connector, and a support rod that are installed inside a roller tubing of the roller shade. The rotation adaptor, the support connector, and the roller tubing are rotationally coupled and free to rotate about the support rod and the support rod is rotationally stationary. The support connector fit within a center tunnel of the rotation adaptor, and the support rod threads through a center through hole of the support connector. The apparatus ensures that the retraction of the screen would automatically stop at a desired, predetermined position.

### CROSS REFERENCE TO RELATED APPLICATIONS

This patent application claims the benefit and priority of Taiwanese Patent Application No. 111211705, filed on Oct. 26, 2022. Taiwanese Patent Applications No. 111211705 is incorporated herein by reference.

### BACKGROUND

### Technical Field

The present disclosure generally relates to mechanisms of retracting and deploying the screen of a roller shade.

### Description of the Related Arts

A roller shade is a shading device that uses a roller that rotates to retract or release a screen. The rotation of the roller can be powered by a power device. Since the power device is usually attached to one end of the roller, the torque provided from that end often cannot be evenly conveyed across the entire length of the roller. The uneven torque causes the roller to retract the screen in an uneven manner, resulting in an uneven appearance of the screen. For longer rollers that are used for wider windows, the uneven retraction can seriously interfere with proper functioning of the roller shade. Furthermore, since such a roller usually has a hollow structure, it is not sufficiently rigid and may droop or deform due to the weight of the screen. The deformed roller may further cause the retraction operation to be uneven.

A cordless roller shade is powered to roll up the screen without a pull-cord. Typically, such a cordless roller shade has a spring mechanism that is pre-torqued, so it has sufficient tension to power the lifting of the screen. However, such pre-torqued tension in the spring may require too much user effort when pulling down the screen, making the cordless roller shade uncomfortable to use.

### SUMMARY

Some embodiments of the invention provide an apparatus for even distribution of torque in a roller shade. The apparatus, a roller synchronizer, includes a rotation adaptor, a support connector, and a support rod that are installed inside a roller tubing of the roller shade. The rotation adaptor, the support connector, and the roller tubing are rotationally coupled and free to rotate about the support rod and the support rod is rotationally stationary. The support connector fit within a center tunnel of the rotation adaptor, and the support rod threads through a center through hole of the support connector. The apparatus ensures that the retraction of the screen would automatically stop at a desired, predetermined position. The apparatus further enhances surface rigidity of the roller, thereby minimizing the curving of the roller tubing due to the weight of the screen.

In some embodiments, the support rod has a rectangular or square cross-section. In some embodiments, the support rod has a triangular cross-section. In some embodiments, the through hole of the support connector is circular shaped, and the support rod has only one top edge upon which the support connector rests. In some embodiments, the support rod is hollow. The support rod may be affixed to a support bracket that is used for mounting the roller shade to wall. In some embodiments, the rotation adaptor has an outer surface that matches an inner surface of the roller tubing. The outer surface of the rotation adaptor may include alternating arching and flat surfaces.

In some embodiments, the roller tubing is rotationally coupled to a bead chain controller for providing torque to the roller tubing. In some embodiments, the apparatus includes a spring for providing torque to the roller tubing, the spring having a first end that is rotationally stationary and a second end that is rotationally coupled with the roller tubing. The apparatus may include a spring controller that is used to pre-torque the spring to counter a weight of a screen of the roller shade. The first end of the spring is affixed to the spring controller, and the spring controller is rotationally independent of roller tubing. The second end of the spring is affixed to a spring joint that fit within a center tunnel of the rotation adaptor. The support rod threads through a center through hole of the spring joint. The spring joint, the rotation adaptor, and the roller tubing are rotationally coupled and free to rotate about the support rod.

The preceding Summary is intended to serve as a brief introduction to some embodiments of the disclosure. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a Summary, Detailed Description and the Drawings are provided. Moreover, the claimed subject matter is not to be limited by the illustrative details in the Summary, Detailed Description, and the Drawings, but rather is to be defined by the appended claims, because the claimed subject matter can be embodied in other specific forms without departing from the spirit of the subject matter.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates the components of a roller synchronizer.

FIGS. 2A-C show cross-section views of the roller synchronizer.

FIGS. 2D-G show cross-section views of the support rod in different embodiments.

FIGS. 3-9 illustrate an example roller shade that uses a bead chain controller as a rotation power source.

FIGS. 10-11 illustrate a cordless roller shade that incorporates a roller synchronizer.

FIGS. 12-14 illustrate pre-torquing a core spring of the cordless roller shade.

FIGS. 15-16 illustrate a cordless roller shade having multiple core springs that incorporates a roller synchronizer.

FIGS. 17-18 illustrate a cordless roller shade in which a retraction limiter is used to limit the retraction of the screen.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

Some embodiments of the invention provide a roller synchronizer that evenly distribute torque in a roller shade. The roller synchronizer enhances surface rigidity of the roller, thereby minimizing the curving of the roller tubing due to the weight of the screen. The roller synchronizer also reduces user effort when pulling down the screen of a roller shade while ensuring that the retraction of the screen would automatically stop at a desired, predetermined position.

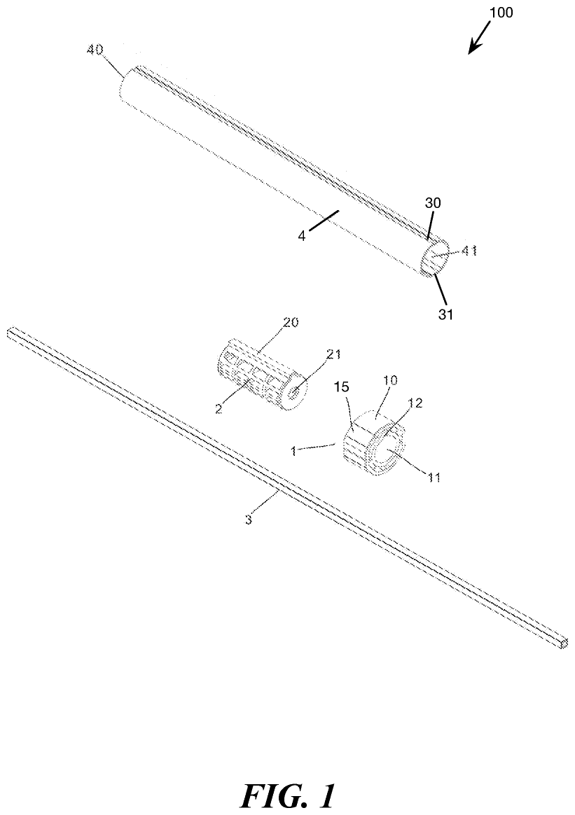

FIG. 1 illustrates the components of a roller synchronizer 100. The roller synchronizer is an assembly that includes a (tubing) rotation adaptor 1, a (rod) support connector 2, and a support rod 3. The support rod 3 is to be inserted through a through hole 21 in the center of the support connector 2, and the support connector 2 is recessed into a center tunnel 11 of the rotation adaptor 1. The shape of the support connector 2 matches the shape of the center tunnel 11 of the rotation adaptor. The support connector 2 has a protrusion 20 that mates with a recess slot 12 along the center tunnel 11 of the rotation adaptor 1. Thus, once mated, the rotation adaptor 1 and the support connector 2 are rotationally coupled. On the other hand, the center through hole 21 is round shaped so that the support connector 2 can freely rotate about the support rod 3. The support rod 3 is fastened to a fixed structure (not illustrated) and does not rotate. The roller synchronizer 100 is to be installed within a roller tubing 4. The roller tubing 4 has two affixing grooves 30 and 31 at opposing side of the roller's outer surface for affixing the screen of the roller shade.

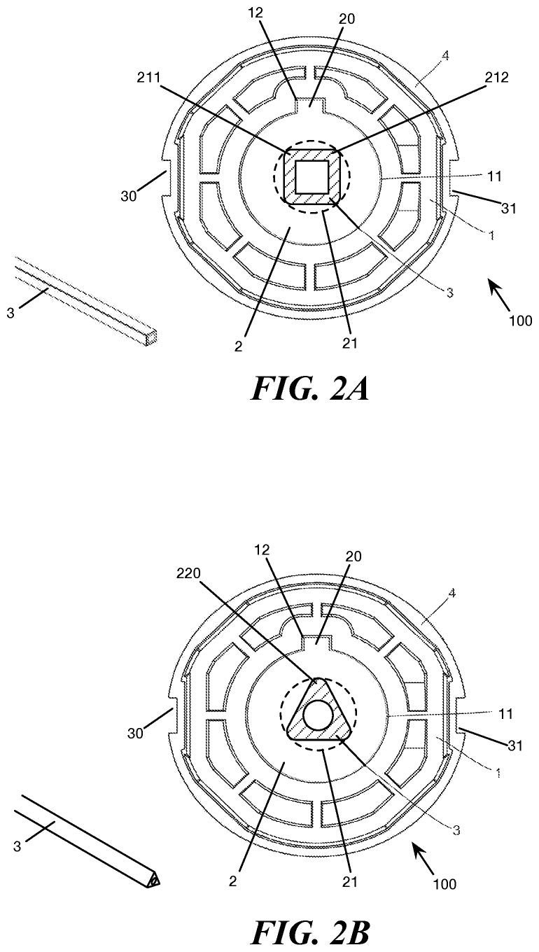

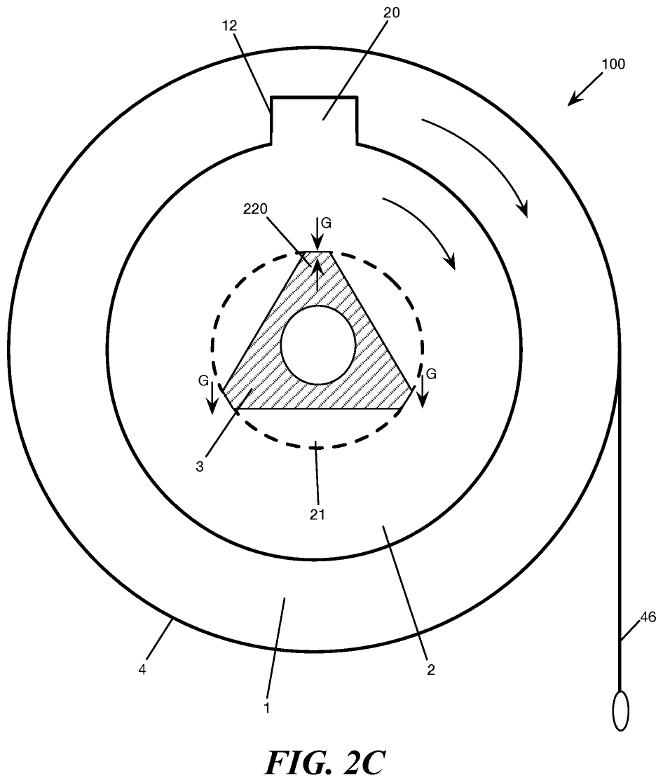

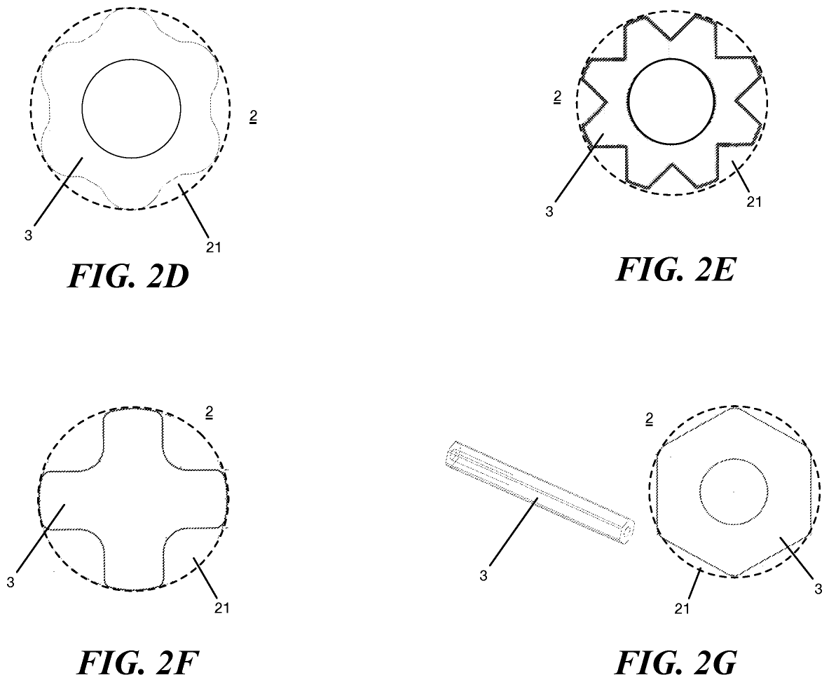

In FIG. 1, the support rod 3 is illustrated as having a square or rectangular cross-sectional shape. However, the support rod 3 may also have a triangular cross-section, or another cross-sectional shape. FIGS. 2A-2C show the cross-section of the roller synchronizer 100, including the rotation adaptor 1, the support connector 2, the support rod 3. The support connector 2 has a protrusion 20 that mates with a recess slot 12 along the center tunnel 11 of the rotation adaptor 1.

The inner surface of the roller tubing 4 and the outer surface of the rotation adaptor 1 have matching features, including alternating arching surfaces 10 and flat surfaces 15. These matching surface features allows the rotation adaptor 1 to be rotationally coupled with the roller tubing 4. The support rod 3 provides surface rigidity to the roller tubing 4 through the rotation adaptor 1 and the support connector 2. The support rod 3 may be constructed from light and rigid material such as aluminum.

FIG. 2A shows a cross-section with a square or rectangular support rod 3. The support rod in this embodiment has four edges (or four vertices in the cross-section) and is hollow with a square or rectangular center cavity. FIG. 2B shows a cross-section with a triangular support rod 3. The support rod in this embodiment has three edges (or three vertices in the cross-section) and is hollow with a circular center cavity.

When the roller tubing 4 is not rotating, the weight or downward force of the screen will cause the roller tubing 4 (and the roller synchronizer 100) to rest at the top edge(s) of the support rod 3 in a balance manner. The top edge(s) of the support rod 3 props up the tightly coupled roller synchronizer 100 (the rotation adaptor 1 and the support connector 2). Since the support rod 3 is stationary and does not rotate, the weight of the screen acting on top edge(s) of the support rod 3 will stop the rotation of the roller synchronizer 100 by stopping its sliding. For example, when the support rod 3 is square shaped, the roller synchronizer 100 may rest at the top two edges 211 and 212 of the rod 3. When the support rod 3 is triangle shaped, the roller synchronizer 100 may rest at the top one edge 220 of the support rod 3. FIG. 2C shows the operation of the triangular shaped support rod. Since the triangular shaped support rod 3 has only one top edge 220 for supporting the roller synchronizer 100, the distribution of the weight of the screen 46 would only act on the top edge of the support rod 3. Since the support rod 3 (and hence the top edge 220) is stationary, the roller tubing 4 would stop sliding/rotating and come to rest in a balanced, stable manner.

More generally, the support rod 3 may have any number of edges (or cross-section vertices). The edges may be provided by flat surfaces or fingers. Depending on the installation, the support rod 3 may have one top edge or multiple top edges that support the weight of roller shade. Each edge may be sharp or rounded, or polished to match the circular surface of the central through hole 21 of the support connector 2. FIGS. 2D-G show cross-section views of the support rod in some additional embodiments.

FIG. 2D shows the support rod having six fingers, which provide six rounded edges (or six rounded vertices in the cross-section) that fit within the center through hole 21 of the support connector 2. FIG. 2E shows the support rod having eight fingers, which provide eight rounded edges or eight rounded vertices that fit within the center through hole 21. FIG. 2F shows the support rod having four fingers, which correspond to four rounded edges or four rounded vertices that fit within the center through hole 21. FIG. 2G shows the support rod having a hexagonal cross-section with six flat surfaces, which provide six edges or six vertices that fit within the center through hole 21.

In some embodiments, a rotation power source is attached to one end of the roller tubing 4 to provide torque to rotate the roller tubing 4 and the roller synchronizer 100. Through the roller synchronizer, the torque is conveyed to the entire roller tubing 4 uniformly and synchronously, allowing the screen to be evenly deployed or retracted, while requiring minimal user effort.

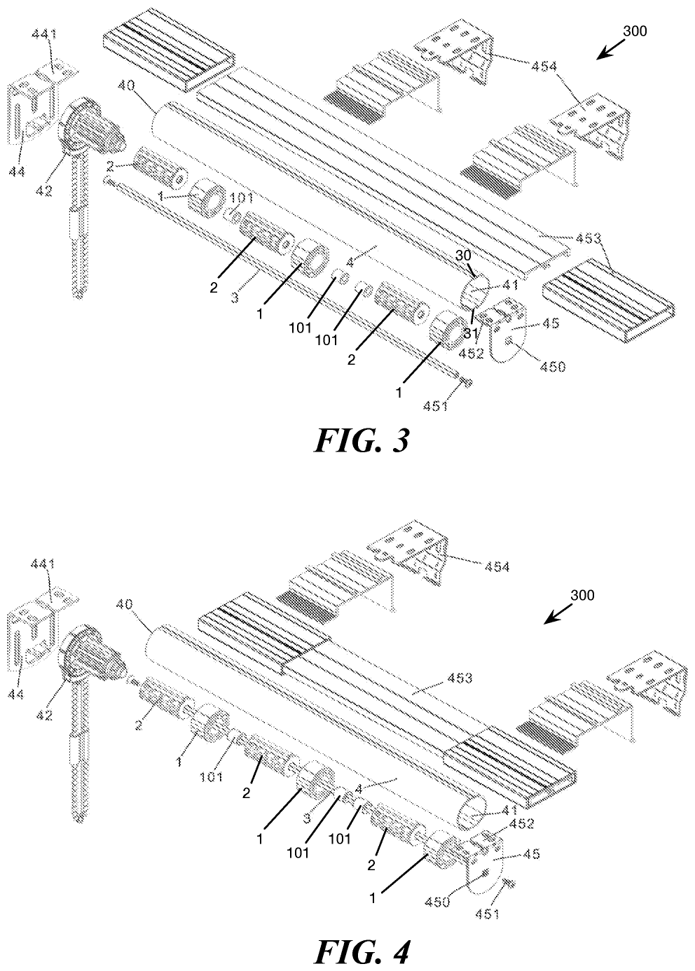

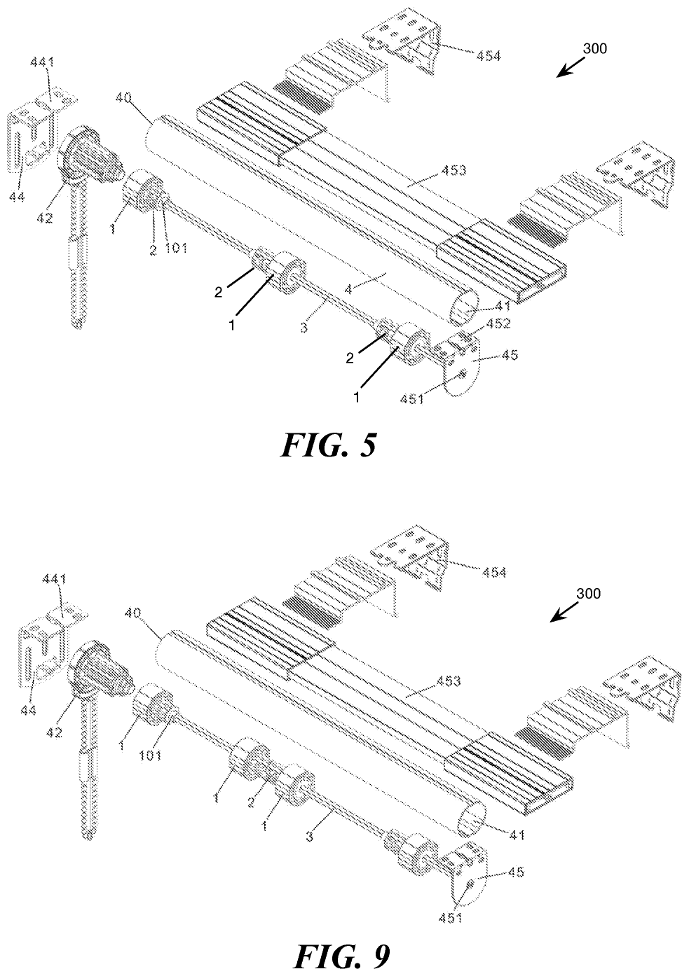

FIGS. 3-9 illustrate an example roller shade 300 that uses a bead chain controller as a rotation power source. FIGS. 3-5 and 9 show exploded views of the example roller shade 300 incorporating the roller synchronizer. As illustrated, one or more rotation adaptors 1 and one or more support connectors 2 are installed on the support rod 3 (the number of rotation adaptors 1 and support connectors 2 installed can be increased or decreased based on the width of the roller shade 300.) Each support connector 2 is tightly fitted into a corresponding rotation adaptor 1. One or more positioning sleeves 101 are also installed along the support rod 3 to fix the horizontal positions of the support connectors 2. The roller synchronizer assembly of the rotation adaptors 1, the support connectors 2, and the support rod 3 are installed within the roller tubing 4. The two openings 40 and 41 at the two ends of the roller tubing 4 are respectively installed a bead chain controller 42 and an end covering (not illustrated). The two ends of the roller tubing 4 are also installed support brackets 44 and 45. The support rod 3 is affixed to the support bracket 45 through an aperture 450 with a fastener 451 such that the support rod 3 does not rotate. The roller tubing 4 is rotationally coupled to the bead chain controller 42 such that when the user pulls on the bead chain, the bead chain controller 42 torques the roller tubing 4 as well as the roller synchronizer within the tubing.

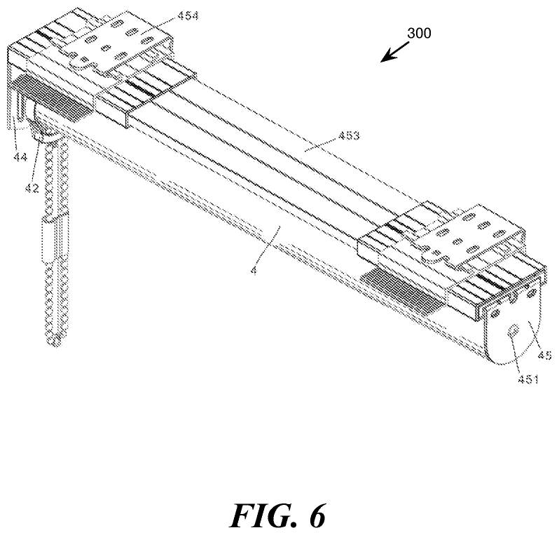

FIG. 6 shows a completed assembly of the roller shade 300 ready for installation at a window. As illustrated, top plates 441 and 452 of the support brackets 44 and 45 are inserted into a mounting railing 453 to install the roller tubing 4 beneath the mounting railing 453. Wall mounting brackets 454 are used to mount the entire roller shade assembly to (a wall surface near) a window.

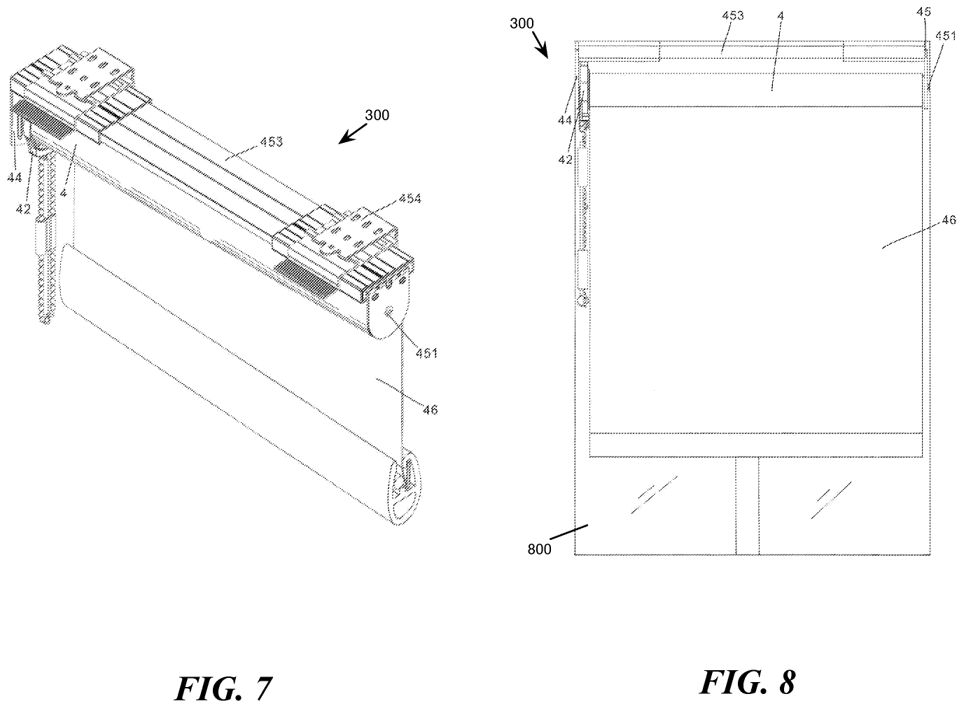

FIGS. 7-8 show the roller shade 300 being used to retract and deploy a screen 46 over a window 800. As illustrated, when the bead chain provided by the bead chain controller 42 is pulled, the bead chain controller 42 rotates and torques the roller tubing 4 to retract or deploy the screen 46 of the roller shade. The roller synchronizer in the roller tubing 4 ensures that the torque is distributed evenly from one end of the roller tubing to the other. The support rod 3 of the roller synchronizer also provides the rigidity to the roller tubing 4 so the tubing does not droop or deform. This allows the screen 46 to maintain an even and smooth appearance.

Traditionally, a bead chain controller relies on an internal spring to stop the sliding motion of the screen of the roller shade. The internal spring is typically configured to have more torque than the weight on the roller tubing (e.g., from the screen), requiring effort from the user when operating the bead chain controller. In some embodiments, the internal spring of the bead chain controller 42 is configured to have less torque than the weight on the roller tubing (e.g., from the screen). This reduces the effort a user may have to exert when using the bead chain controller to retract or deploy (release) the screen.

In some embodiments, the roller synchronizer is used to facilitate smooth operations with reduced user effort in a cordless roller shade. The cordless roller shade has a core spring to torque the roller tube for lifting or retracting the screen without a pull-cord. The roller synchronizer is coupled with the core spring to ensure even distribution of the torque across the roller tubing. When the roller tubing rotates due to the screen being pulled down, the roller synchronizer also rotates. As the screen moves up or down (retracted or deployed), the core spring also rotates and winds/unwinds correspondingly. The core spring may be pre-wound or pre-torqued to match the weight of the screen at a desired retraction position. Thus, the roller shade is configured to retract the screen to a predetermined position at which the weight of the screen matches the torque of the core spring. This facilitates smooth motion of the screen retraction and allows the user to use less force or effort.

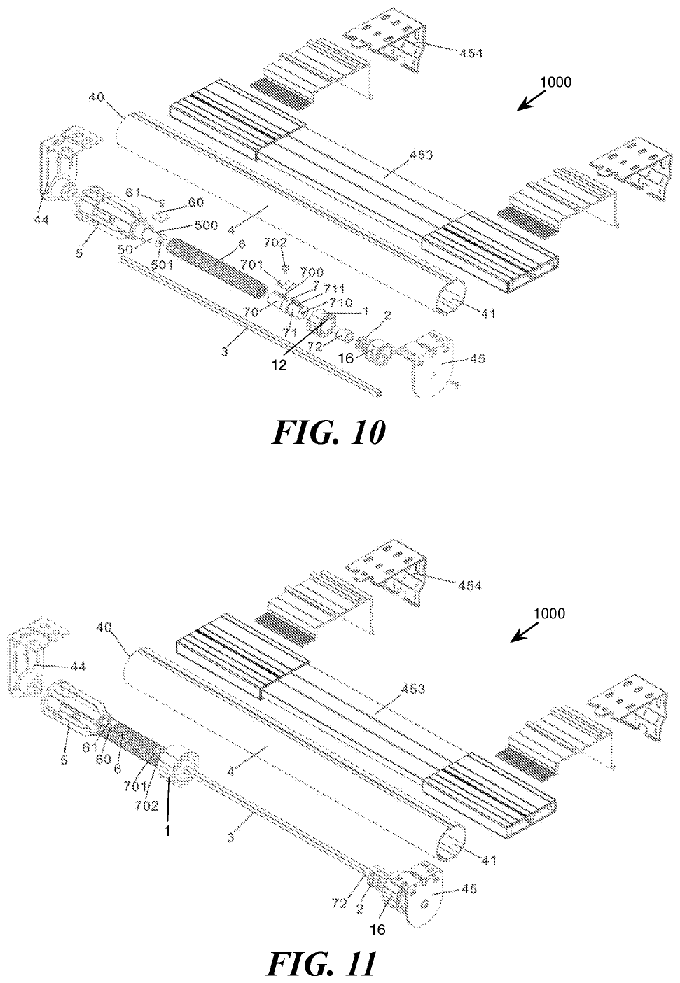

FIGS. 10-11 illustrate a cordless roller shade 1000 that incorporates a roller synchronizer. As illustrated, a spring controller 5 has a frontend cylinder 50 with a groove 500. There is an aperture 501 at the center of the frontend cylinder 50. The frontend cylinder 50 is sleeved by a core spring 6. The core spring 6 is affixed at one end to the frontend cylinder 50 of the spring controller 5 by an affixing plate 60 and fastener 61. The other end of the core spring 6 sleeves a spring joint 7. The spring joint 7 has two cylindrical sections 70 and 71. The spring joint 7 also has a through-hole 710 at the center, a groove 700 along the surface of the cylindrical section 70, and a protrusion 711 along the surface of the cylindrical section 71. An affixing plate 701 and a screw 702 affixes the core spring 6 to the cylindrical sections 70 of the spring joint 7. The cylindrical section 71 is fitted with a first tubing rotation adaptor 1 to form a first roller synchronizer, with the protrusion 711 recessed into a recess slot 12 of the rotation adaptor 1. Thus, the core spring 6 has a first end that is rotationally stationary (e.g., affixed to the spring controller 5 and rotationally independent of the roller tubing 4) and a second end that is rotationally coupled with the roller tubing 4.

A second tubing rotation adaptor 16 is mated with a support connector 2, forming a second roller synchronizer with horizontal position fixed by a positioning sleeve 72. The support rod 3 threads through the roller synchronizers as well as through-hole 710 of the spring joint 7 and reach the aperture 501 of the spring controller 5. The assembly is installed within the roller tubing 4. The two roller synchronizers are rotationally coupled with the roller tubing 4. The spring controller 5 and the support rod 3 are fixed to a support bracket 44 and are not rotationally coupled with the roller tubing 4.

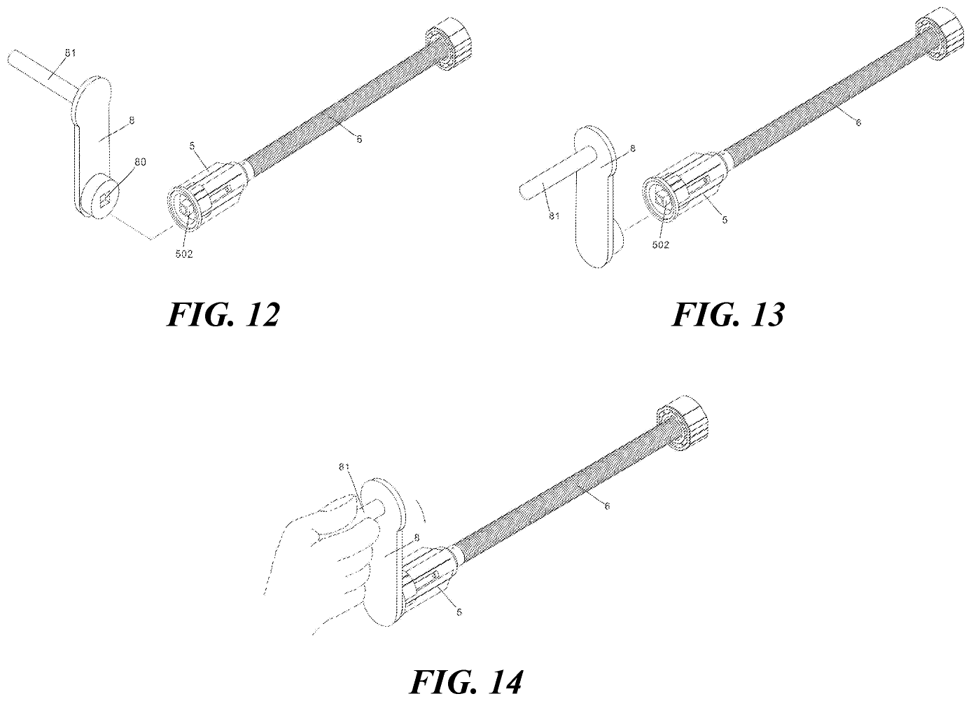

FIGS. 12-14 illustrate pre-torquing the core spring of the cordless roller shade 1000. The pre-torquing of the cordless roller shade adds tension to the core spring sufficient to counter or match the weight of the screen of the roller shade. As illustrated, a winding tool 8 has a square hole 80 that can mate with a corresponding square protrusion 502 of the spring controller 5. The user can crank a lever 81 in a clockwise direction a predetermined number of turns or a predetermined angular displacement to wind the core spring 6. This gives the roller shade sufficient tension in the spring to cordlessly retract the screen. Returning to FIGS. 10 and 11. The pre-torqued cordless roller shade 1000 can then be installed by having the two ends 40 and 41 of the roller tubing 4 installed onto support brackets 44 and 45. The support brackets 44 and 45 are inserted into the mounting railing 453 to install the roller tubing 4 beneath the mounting railing 453. Wall mounting brackets 454 are used to mount the entire roller shade assembly 1000 to (a wall surface near) a window as a cordless roller shade.

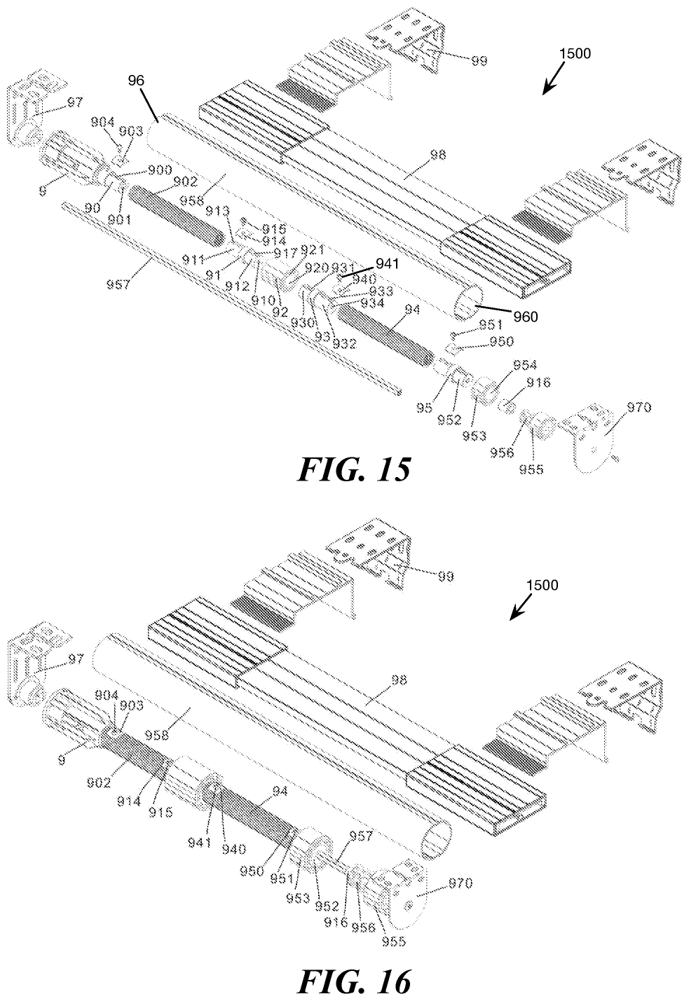

FIGS. 15 and 16 illustrate a cordless roller shade 1500 having multiple core springs that incorporates a roller synchronizer. As illustrated, a spring controller 9 has a frontend cylinder 90 with a groove 900. There is an aperture 901 at the center of the frontend cylinder 90. The frontend cylinder 90 is sleeved by a core spring 902. The core spring 902 is affixed at one end to the frontend cylinder 90 of the spring controller 9 by an affixing plate 903 and fastener 904. The other end of the core spring 902 sleeves a first spring joint 91. The spring joint 91 has two cylindrical sections 911 and 912. The first spring joint 91 also has a through-hole 910 at the center, a groove 913 along the surface of the cylindrical section 911, and a protrusion 917 along the surface of the cylindrical section 912. An affixing plate 914 and a screw 915 affixes the core spring 902 to the cylindrical sections 911 of the spring joint 91. The cylindrical section 912 is fitted into a center hole 920 of a first tubing rotation adaptor 92 to form a first roller synchronizer, with the protrusion 917 recessed into a recess slot 921 of the rotation adaptor 92.

The first rotation adaptor 92 is also fitted with a second spring joint 93, which has two cylindrical sections 930 and 932 and a center through hole 934. The cylindrical section 930 is fitted into the center hole 920 of a first tubing rotation adaptor 92 as part of the first roller synchronizer, with a protrusion 931 recessed into the recess slot 921 of the rotation adaptor 92. The cylindrical section 932 of the spring joint 93 has a groove 933. The spring joint 93 is connected to a second core spring 94. One end of the core spring 94 is affixed to the cylindrical section 932 of the spring joint 93 by an affixing plate 940 and a fastener 941. The other end of the core spring 94 sleeves another spring joint 95. An affixing plate 950 and a fastener 951 affixes the core spring 94 to the spring joint 95. A cylindrical section 952 of the spring joint 95 is fitted into a center opening 954 of a second rotation adaptor 953 to form a second roller synchronizer.

A third rotation adaptor 955 is mated with a support connector 956 to form a third roller synchronizer. Its position is fixed by a positioning sleeve 916. A support rod 957 goes through center through holes of the three roller synchronizers, the core springs 902 and 94, the spring joints 91, 93, 95, and the spring controller 9. The entire assembly along the support rod 957 is installed within a roller tubing 958. The three roller synchronizers are rotationally coupled with the tubing 958. The openings 96 and 960 at the two ends of the tubing 958 are respectively installed the spring controller 9 and support brackets 97 and 970. Both the spring controller 9 and the support rod 957 are fixed to the support bracket 97 and are not rotationally coupled with the tubing 958.

The cordless roller shade 1500 (can be pre-torqued) can be installed by having the support brackets 97 and 970 inserted into the mounting railing 98 to install the roller tubing 958 beneath the mounting railing 98. Wall mounting brackets 99 are used to mount the entire roller shade assembly 1500 to (a wall surface near) a window as a cordless roller shade.

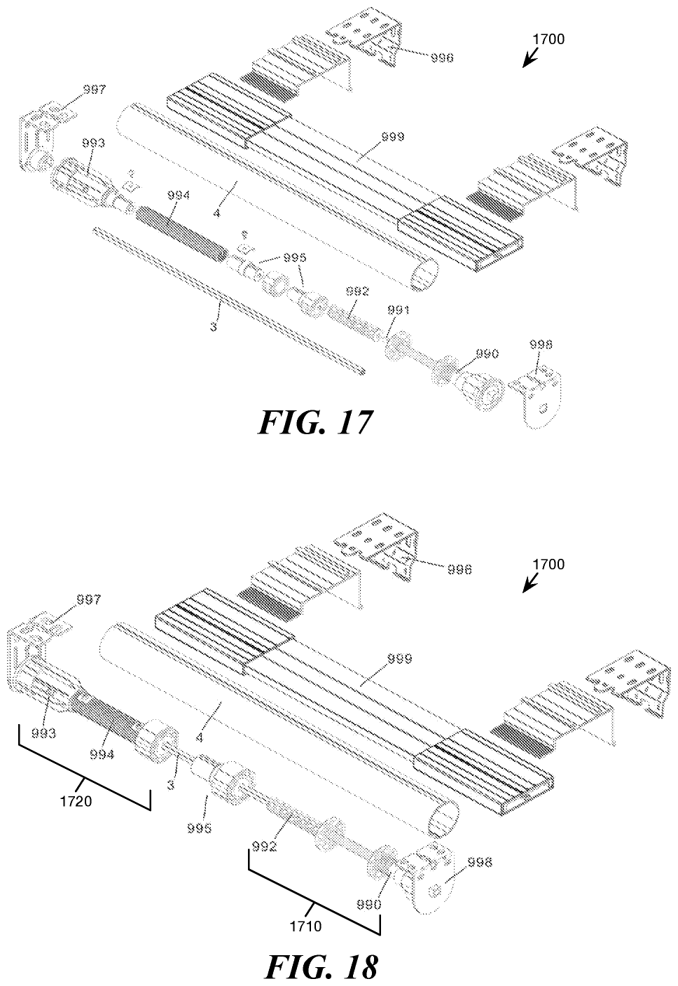

In some embodiments, a retraction limiter is installed in the roller tubing to limit the retraction of the screen at a desired position. FIGS. 17-18 illustrate a cordless roller shade 1700 in which a retraction limiter 990 is used to limit the retraction of the screen. As illustrated, the retraction limiter 990 is coupled by a squared-shaped protrusion 991 with an elongated joint 992 to form a retraction-limiting structure 1710. A core spring 994 is affixed to a spring controller 993 at one end and to a roller synchronizer 995 at the other end to form a torque structure 1720. The support rod 3 threads through the torque structure 1720 and the retraction-limiting structure 1710, and the assembly is installed into the roller tubing 4. The roller synchronizer 995 is rotationally coupled with the roller tubing 4 but the spring controller 993 is not. Support brackets 997 and 998 are installed at both ends of the roller tubing 4. The cordless roller shade 1700 can be installed by having the support brackets 997 and 998 inserted into the mounting railing 999 to install the roller tubing 4 beneath the mounting railing 999. Wall mounting brackets 996 are used to mount the entire roller shade assembly 1700 to (a wall surface near) a window as a cordless roller shade. The retraction limiter 990 can be configured to set a desired position at which the retraction of the screen will stop. Thus, when the torque structure 1720 torques the roller tubing 4 through the roller synchronizer 995 to retract the screen, the retraction will stop at the desired position.

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. An apparatus comprising:
a roller tubing of a roller shade;
a rotation adaptor; and
a support rod,
wherein the support rod and the rotation adaptor are installed inside the roller tubing,
wherein the rotation adaptor and the roller tubing are rotationally coupled and free to rotate about the support rod and the support rod is rotationally stationary.

2. The apparatus of claim 1, further comprising a support connector that fit within a center tunnel of the rotation adaptor, wherein the support rod threads through a center through hole of the support connector.

3. The apparatus of claim 2, wherein the through hole of the support connector is circular shaped.

4. The apparatus of claim 3, wherein the support rod has only one top edge upon which the support connector rests.

5. The apparatus of claim 2, wherein the support rod has polished edges that matches the inner surface of the support connector.

6. The apparatus of claim 1, wherein the rotation adaptor has an outer surface that matches an inner surface of the roller tubing.

7. The apparatus of claim 6, wherein the outer surface of the rotation adaptor comprises alternating arching and flat surfaces.

8. The apparatus of claim 1, wherein the support rod is hollow.

9. The apparatus of claim 1, wherein the support rod has a rectangular or square cross-section.

10. The apparatus of claim 1, wherein the support rod has a triangular cross-section.

11. The apparatus of claim 1, wherein the support rod has a hexagonal cross-section.

12. The apparatus of claim 1, wherein the support rod is affixed to a support bracket that is used for mounting the roller shade to wall.

13. The apparatus of claim 1, further comprising a spring for providing torque to the roller tubing, the spring having a first end that is rotationally stationary and a second end that is rotationally coupled with the roller tubing.

14. The apparatus of claim 13, further comprising a spring controller that is used to pre-torque the spring to counter a weight of a screen of the roller shade, wherein the first end of the spring is affixed to the spring controller, wherein the spring controller is rotationally independent of roller tubing.

15. The apparatus of claim 13, wherein the second end of the spring is affixed to a spring joint that fit within a center tunnel of the rotation adaptor, wherein the support rod threads through a center through hole of the spring joint, wherein the spring joint, the rotation adaptor, and the roller tubing are rotationally coupled and free to rotate about the support rod.

16. The apparatus of claim 13, wherein the roller tubing is rotationally coupled to a bead chain controller for providing torque to the roller tubing.
